(19) United States
(12) Patent Application Publication
(10) Pub. No.: US 2014/0262583 A1
(43) Pub. Date: Sep. 18, 2014

(54) Modular Off-Road Vehicle

(71) Applicant: Dale Url, Scappoose, OR (US)

(72) Inventor: Dale Url, Scappoose, OR (US)

(21) Appl. No.: 13/842,588

(22) Filed: Mar. 15, 2013

(51) Int. Cl. B62D 63/02; B60K 17/34; B62D 33/023

(52) U.S. Cl. CPC B62D 63/025; B62D 33/023; B60K 17/34
USPC 180/233; 296/183.1; 180/89.1

(57) ABSTRACT

An off road vehicle of modular construction, which a user may insert or remove modules to perform particular functions.

### BACKGROUND

Robust vehicles capable of operation on unimproved surfaces find application on farms, at construction sites, in industrial settings, and in the military. A wide variety of such vehicles, for single or multiple riders, are well known. While as a class off-road vehicles are diverse and fulfill many roles, individual vehicles are typically limited. A compact and maneuverable ATV useful for a hunter to travel well into the woods might seat only one or two people. A farm tractor can accommodate a variety of implements, but is ill-suited to transport workers to distant fields for picking. A multi-seat ATV could transport workers, but would not have the cargo capacity for harvested crops or related cargo.

The capital costs of maintaining multiple vehicles, each with a limited purpose, are substantial. Furthermore, the capital costs of maintaining multiple assembly lines, each for a different vehicle, or else incurring the costs of frequent re-tooling, limit the ability of manufacturers to meet the demand of the market, especially for markets that are relatively small.

### SUMMARY

A vehicle comprising at least a front and a rear module, the modules being capable of attachment to one another to form a substantially unitary vehicle, but also capable of detachment without damage to accommodate one or more modules between them.

### BRIEF DESCRIPTION OF THE DRAWINGS

FIG. 1 is a perspective view of one embodiment of a modular off-road vehicle showing front and rear drive modules attached to one another.

FIG. 2 is a perspective view of one embodiment of a modular off-road vehicle showing front and rear drive modules with an additional passenger module mounted between them.

FIG. 3 is a perspective view of one embodiment of a modular off-road vehicle showing front and rear drive modules with a passenger module and a cargo module mounted between them.

FIG. 4 is a perspective view of the forward portion of the front drive module depicted in FIGS. 1-3.

FIG. 5 is a perspective view of the rearward portion of the front drive module depicted in FIGS. 1-3 showing the connections to be made with the rear drive module or an intermediate module.

FIG. 6 is a perspective view of the forward portion of the rear drive module depicted in FIGS. 1-3 showing the connections to be made with the front drive module or an intermediate module.

FIG. 7 is a perspective view of the rearward portion of the rear drive module depicted in FIGS. 1-3 showing aspects of the cargo bed in more detail.

FIG. 8 is a detailed view of the accessory coupler found on the rear drive module.

FIG. 9 is a perspective view of the forward portion of an intermediate passenger module depicted in FIGS. 2-3 showing the connections to be made with the front drive module or another intermediate module.

FIG. 10 is a perspective view of the rearward portion of an intermediate passenger module depicted in FIGS. 2-3 showing the connections to be made with the rear drive module or another intermediate module

FIG. 11 is a detail view of the forward facing connections found on the rear drive module and intermediate modules, showing how they connect with a driveline coupler from another module.

FIG. 12 is a perspective view of the rear drive module showing how the side and rear panels of a cargo box may be removed to form a flat bed.

FIG. 13 is a perspective view of the rear drive module showing the side and rear panels of the cargo box affixed to the rear drive module to form a flat bed.

FIG. 14 is a side elevation of the embodiment of an off-road vehicle depicted in FIG. 1.

FIG. 15 is a detail of the joint between two modules showing the collar that prevents deformation of the frame under pressure from bolts and nuts being tightened.

FIG. 16 is a detail showing the right panel of the bed, including the end of the top rail intended to insert into a box on the rear panel of the bed.

FIG. 17 is a detail showing the end of the top rail of the right panel actually inserted into the box on the rear panel of the bed, as it would appear in operation.

FIG. 18 is a detail showing the hinges connecting the right panel of the bed to the right side of the bed.

FIG. 19 is a detail showing how the hinges connecting the right panel of the bed to the right side of the bed may be separated from each other to allow removal of the right panel.

### DETAILED DESCRIPTION

A sturdy vehicle built modularly can be adapted to any use by the addition or subtraction of chassis sections designed for particular purposes.

The most basic components required are the front drive module 10, as shown in FIGS. 4 and 5, and the rear drive module 22, as show in FIGS. 6 and 7. The front drive module 10 comprises ground-contacting surfaces 14 which may be used to steer the vehicle. In a preferred embodiment, the ground contacting surfaces 14 comprise wheels, and are also used to provide motive power. They may also take the form of tracks, as are familiar in earth-moving equipment and military vehicles, or, in snowy environments, skis. The front drive module 10 also includes a seat 16 for a driver and passengers, directional control device 18 (examples include a steering wheel or set of handlebars), and acceleration control 21 and braking control 23 (examples include pedals, rotating handles, and hand-operated levers). The front drive module 10 may also include such items as a keyhole for controlling starting and stopping of an engine, onboard electronics such as a radio or GPS, a control panel for adjustable suspension, and gauges to monitor the condition of the vehicle. In a preferred embodiment, the controls are very similar to the controls of an automobile.

The front drive module 10 may also feature a motor 12 to propel the vehicle. The motor may be powered by any conventional means, including electrical, internal combustion, compressed gas, or any combination of known means for propelling a vehicle. Preferably, this motor 12 is located underneath the seat 16 in the front drive module 10, and connected to the wheels 14 of the front drive module 10 through a conventional transmission and a differential 15 as shown in FIG. 14. To be located under the seat, the motor 12 is preferably of a boxer or opposed cylinder design, but may also be an inline engine provided it is capable of mounting horizontally for compactness. The motor 12 may be mounted transversally or longitudinally, according to design preference. A rear-facing driveline coupler 20 is located within the frame of the front drive module 10, where it is intended to join another module.

The rear drive module 22 comprises ground-contacting surfaces 24 and a differential 27, along with a forward-facing driveline coupler 26 compatible with the rear-facing driveline coupler 20 found at the rear of the front drive module 10. In a preferred embodiment, the rear drive module 22 has a pair of wheels 24. However, more than two wheels 24 are possible, as are tracks. Preferably, the ground contacting surface 24 of the rear drive module 22 is designed to participate in the steering of the vehicle. For a wheeled vehicle, the wheels 24 in the rear drive module 22 are designed to pivot about an axis 28 substantially perpendicular to the ground surface, in response to mechanical control from a servo, hydraulic or pneumatic cylinder, or other actuation device (not shown). If tracks are used, they may be designed to run at different speeds to promote turning. The differential 27 permits the ground-contacting surfaces 24 to make turns smoothly as is conventional in automobiles and similar vehicles. In one embodiment, the driveline couplers 20, 26 on both modules 10, 22 are identical but designed to join matingly so as to transfer torque from the front drive module to the rear drive module. A non-limiting example is a flange with holes to accommodate bolts for joining. In another embodiment, the driveline coupler is a spline coupler.

Both front and rear drive module are built around spine 11, which in a preferred embodiment comprises rectangular metal tubes welded together to form an elongate plate-like structure. This spine is connected to the suspension of the vehicle and provides stiffness and support to the entire body.

Both the rear drive module 22 and the front drive module 10 are preferably designed to function on difficult unimproved terrain. High ground clearance and substantial suspension travel are essential. In a preferred embodiment, the suspension is adjustable due to the use of air springs. This permits control over ride stiffness, compensation for sagging caused by cargo, and levelling of the vehicle when loaded. The frames 30, 32 of both modules must be able to withstand both static forces when loaded and parked on uneven ground, and dynamic forces such as bumps and jolts, which occur as the vehicle travels. The frames 30, 32 are preferably made of steel or aluminum tubing, welded together for rigidity. Other material choices may be made according to design preferences.

Preferably, the front and rear drive modules have accessory coupler 100 affixed to the spine 11, as best shown in FIG. 8. Accessory coupler 100 comprises two receivers 102, each substantially identical to a standard Class III trailer hitch receiver, having a square opening of approximately two inches on a side, and a hole approximately ⅝ inches through the receiver 102 to receive a pin. These couplers 100 may be used for the mounting of accessories such as snowplows or for the towing of trailers.

The rear drive module 22 and the front drive module 10 are capable of being detachably affixed to one another. The structural components may be joined by bolts, hooks, pins, or any other means intended to secure two components together firmly enough to permit operation of the connected modules as a single unitary vehicle, as best shown in FIG. 1. It is important that the vehicle, when in operation, constitute a rigid structure comparable in performance to a similar vehicle designed and built in a single piece. In one embodiment, bolts 34 and nuts 36 are used for maximum versatility and solidity in attachment. To prevent deformation of the tubing used to make the frame, collars 35 are welded into the frame to bear the stress caused by the tightening of bolts 34 and nuts 36, as best shown in FIG. 15. The frame must be smooth where it mates with its counterpart. Welding the collars 35 in place therefore requires that the collars 35 or frame be chamfered so that the gab may be filled with weldment. If the collar is fitted and welded without the chamfer, then most of the weldment will be ground off to make the frame smooth, leaving inadequate strength once the grinding is accomplished. In alternative embodiments, bolts 34 attach to threaded portions of the frame, which design only permits modules to be joined in certain orientations. Pins may be provided with corresponding holes in the neighbouring module to guide bolt holes into alignment. Dovetails, mortise and tenon, and tongue-and-groove joints may all be employed. These attachment methods can be designed to have the advantage of not requiring tools, as bolts 34 and nuts 36 do, but are more expensive to manufacture and more difficult to secure in a way that results in a truly rigid structure.

Between the front drive module 10 and the rear drive module 22, intermediate modules 38, 40 may be placed to alter the function of the vehicle. For instance, a passenger module 38, depicted in FIGS. 9 and 10, (or more than one) containing seats 16 for riders may be placed between the front drive module 10 and the rear drive module 22 to expand the seating capacity, as shown in FIG. 2. A cargo module 40 could be added, featuring whatever form of cargo containment was needed. A special-purpose module containing equipment dedicated to a particular task could also be inserted. For instance, a module intended for the laying of pipe or cable might include a reel to hold the item to be laid and a motor for pushing it out and laying it into a prepared trench. An agricultural module might contain a tank and sprayers for applying fertilizer or pesticides. Even a toilet module is possible, and more useful than conventional portable toilets when it is expected that workers will need to move often.

Some combination of intermediate modules these may be chosen for a particular purpose. For instance, when moving workers to a worksite, an operator might place a passenger module 38 to provide seating for the workers, and a cargo module 40 fitted with tool containers, to transport the tools required at the worksite, as shown in FIG. 3. On the other hand, an agricultural or construction employer might provide a cargo module 40 containing water tanks and a food-service module containing coolers or refrigerators, to bring lunch and hydration to workers who find themselves an inconvenient distance from buildings. A military field ambulance might contain a module with a litter or litters for carrying the wounded, and another filled with equipment and consumables such as bandages, disinfectant, and splints.

Each intermediate module 38, 40 carries on its underside a driveline segment 42, with driveline couplers 44, 46 at the front and back, as shown in FIG. 11. These couplers join matingly with the rear-facing driveline coupler 20 on the front drive module 10 and the forward-facing driveline coupler 26 found on the rear drive module 22, to transmit torque to the rear wheels 24. Control connections such as cables, hydraulics, and electrical plugs may be located in any convenient place, using couplers designed for easy and rapid attachment and detachment. In one embodiment, control connections are arranged on the inside of the vehicle. Well-known examples of useful couplers include: Connectors 48 used to connect trailers to automobiles, which transmit electrical power necessary to operate signal lights or quick-detach self-sealing hydraulic couplings 50, which can be used to transmit braking power when brakes are operated hydraulically and steering impulses for the rear wheels, or pneumatic fittings for the same purpose. Any couplers which permit safe transmission of signals and power from one module to another may be used, and a wide variety are commercially available and well-known in the art. In a preferred embodiment, the placement of connections is standardized such that any module may replace any other while still allowing for safe operation of the vehicle.

Intermediate modules 38, 40 may or may not have ground-contacting surfaces. In the simplest embodiment, intermediate modules merely join the front and rear drive modules 10, 22, and are carried between them. However, in an alternative embodiment, an intermediate module might have free-running wheels intended to help support the weight of the cargo or passengers contained within it. This is particularly helpful in soft ground or snow, where the vehicle's tendency to sink in is mitigated by additional ground-contact surface area. The wheels might also be connected to the driveline segment 42 and steering mechanism to improve performance on slippery or soft ground.

In addition to versatility as discussed above, emergency repairs and routine maintenance are simplified for applications in which a large number of vehicles are deployed. If the engine in a particular vehicle requires service or repair, a second front drive module 10 may be substituted to keep the remainder of the vehicle in service, while the first front drive module 10 is taken to the shop by itself. A similar substitution may be made for any module on the vehicle that needs attention. Of course, the same principle applies to replacement of modules that are irreparably damaged or destroyed. Thus modularity can greatly reduce downtime and lower the total number of vehicles required for a given business.

Modularity also lowers the cost of customization. When a user has a highly specialized need which is not met by the marketplace, it is relatively inexpensive to purchase a generic empty intermediate module and then outfit it to suit that specialized need. Then the specialized module may be fitted to an otherwise generic vehicle. The capital cost of a customized module is much lower than the cost of a customized vehicle.

Because both the number and type of intermediate modules can be changed by a user, the vehicle that is the subject of this application is of variable, user-selectable length.

Both the front and rear drive modules preferably have cargo beds 54, 55 for carrying whatever a user may wish to transport. The beds 54, 55 are preferably made by welding square or rectangular steel or aluminum tubing together to give a strong “corrugated” structure which is both structurally rigid and resistant to dents and other damage. A bed 54, 55 so constructed not only requires no additional frame or support structure to retain its shape, but also forms a part of the frames 30, 32 of the vehicle and contributes rigidity. It should be noted that due to warpage caused by heating, the bed is preferably welded with beads of less than 1″ long, evenly spaced along the length of the tubes being welded. Also preferably, both sides of the tubes are welded at once so that heat stresses are opposed to each other and as closely balanced as possible. Distortion may be relieved by heating to release the trapped stress as is well known in the art.

In a preferred embodiment, the rear bed 54 may be converted from a cargo-box design, resembling the bed of a pickup truck (shown in FIGS. 6 and 7), to a flat bed design, as depicted in FIGS. 12 and 13. The bed 54 has a front 56, rear 58, right 60 and left 62 sides, with corresponding front 66, rear 68, right 70 and left 72 panels. The front panel 66 is rigidly affixed along the front 56 of the bed 54, while panels 68, 70, 72 are detachably affixed along their respective sides. The panels 66, 68, 70, 72 designed to interlock with one another and the bed to form a 5-sided rectangular box as show in FIG. 7. They may be joined in any convenient manner, such as pins, bolts, or dovetails. In a preferred embodiment, top rails 78, 80 on the right 70 and left 72 panels are slightly longer than the remainder of the panel. Top rails 78, 80 overhang the front 66 and rear 68 panels. A pin 82 may be inserted through the top rails 78, 80 into the front 66 and rear 68 panels, to secure the right 70 and left 72 panels. To maximize strength, box 84 is attached to rear panel 68. Box 84, comprised of steel plates welded together, completely surrounds end 86 of the top rails 78, 80 to capture them and prevent the right 70 and left 62 panels from bending outward under the strain of a full load of cargo, as shown in FIGS. 15 and 16. In this way the force is not borne entirely by relatively small pin 82, and indeed pins 82 can even be omitted from the end 86 if preferred.

Preferably, panels 68, 70 and 72 are joined to bed 54 by removable hinges 101, as shown in FIGS. 18 and 19. Hinges 103 comprise a female half 103, which is substantially a round tube welded to the bed 54, and male half 104, which is a pin sized so as to fit into the female half 103, welded to the panel 68, 70, or 72. Preferably, the bed 54 has at least 3 female halves 103 per side. To attach a panel 68, 70, or 72, a user aligns the male haves 104 on the panel 68, 70, or 72 with the corresponding female halves 103 on the rear 58, right 60. or left 62 side, and slides the male halves 104 into the female halves 103. The panel can then be folded up or down as desired.

Below the bed along the rear 58, right 60, and left 62 sides are triangular supports 74 mounted on hinges 76, which fold flat against the body 78 when the bed 34 is used as a box. At least two hinges 76 must be found on each side, although more may be used for increased strength. When the bed 54 is to be used in a flat configuration, a user can fold the supports 74 out to carry the weight of the panels 68, 70, 72. The panels 68, 70, 72 may then be detached from one another and attached to the supports 74. The supports may be joined to the panels 68, 70, 72 in any well-known manner, including bolts, pins, and dovetails, or they may be simply permitted to lay flat with their position retained by a combination of weight on supports 74 and the hinges 101.

In a preferred embodiment, the bed 54 and panels 66, 68, 70, 72 are made of rectangular mild steel tubing with an approximate outside dimension of 30 mm×50 mm. The bed 54 is primarily composed of tubing with a wall thickness of approximately 1.5 mm, but uses a wall thickness of 2.5 mm for those tubes which are attached to the remainder of the frame. The panels 66, 68, 70, 72 are preferably composed of tubes having a wall thickness of approximately 1.0-1.2 mm, while the top rails 78, 80 are thicker, at 2.0-2.5 mm, to resist damage.

The terms and expressions which have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims which follow.

1. A vehicle comprising:
a. a front drive module, comprising a ground-contacting surface, a directional control device, an acceleration control, and a brake control; and
b. a rear drive module, comprising a ground-contacting surface, wherein said front and rear drive modules are rigidly attached to form a substantially unitary vehicle, and wherein said front and rear drive modules are detachable from one another by an end user.

2. The vehicle of claim 1 wherein the ground-contacting surfaces are wheels.

3. The vehicle of claim 2 consisting of exactly four wheels.

4. The vehicle of claim 1 wherein the ground-contacting surfaces of both the front and rear drive modules are capable of propelling the vehicle.

5. The vehicle of claim 1 wherein the ground contacting surfaces of both the front and rear drive modules are capable of controlling the direction of travel while the vehicle is in motion in response to user inputs to the directional control device.

6. The vehicle of claim 1 further comprising an intermediate module positioned between said front drive module and said rear drive module, and rigidly attached to both to form a substantially unitary vehicle, and wherein said front and rear drive modules and said intermediate module are detachable from one another by a user.

7. The vehicle of claim 1 comprising a rear-facing driveline coupler on said front drive module and a forward-facing driveline coupler on said rear drive module, said couplers capable of interacting so as to transmit torque between said drive modules.

8. The vehicle of claim 7 comprising at least one intermediate module, said intermediate module comprising a driveline, a forward-facing driveline coupler affixed to said driveline and capable of interacting with the rear-facing driveline coupler of the front drive module, and a rear-facing driveline coupler affixed to said driveline and capable of interacting with said forward-facing driveline coupler of the rear drive module, so as to transmit torque between said drive modules through said driveline.

9. The vehicle of claim 1 comprising a rear-facing hydraulic coupler on said front drive module and a forward-facing hydraulic coupler on said rear drive module, said couplers being so designed as to prevent the escape of hydraulic fluid when not in use, and capable of interacting so as to transmit hydrostatic pressure between said drive modules.

10. The vehicle of claim 9 comprising at least one intermediate module, said intermediate module comprising a hydraulic line, a forward-facing hydraulic coupler operably connected to said hydraulic line and capable of interacting with the rear-facing hydraulic coupler of the front drive module, and a rear-facing hydraulic coupler operably connected to said hydraulic line and capable of interacting with said forward-facing hydraulic coupler of the rear drive module, said couplers being so designed as to prevent the escape of hydraulic fluid when not in use, and capable of interacting so as transmit hydrostatic pressure between said drive modules through said hydraulic line.

11. A cargo container for a vehicle, comprising:
a. a substantially flat bed having a front side, a rear side, a right side, and a left side;
b. a plurality of supports mounted beneath each of the right side, left side, and rear side, said supports capable of extending substantially perpendicular to the side under which they are mounted, and also capable of folding to a position substantially parallel to said side;
c. a front panel, said front panel being rigidly attached proximate the front side and extending along said front side substantially perpendicular to said bed;
d. a rear panel capable of being detachably affixed proximate said rear side, extending along said rear side substantially perpendicular to said bed, said rear panel also capable of being detachably affixed to said supports in a position substantially parallel to said bed when said supports are extended perpendicular to said rear side;
e. a right panel capable of being detachably affixed proximate said right side, extending along said right side substantially perpendicular to said bed, said right panel also capable of being detachably affixed to said supports in a position substantially parallel to said bed when said supports are extended perpendicular to said right side; and
f. a left panel capable of being detachably affixed proximate said left side, extending along said left side substantially perpendicular to said bed, said left panel also capable of being detachably affixed to said supports in a position substantially parallel to said bed when said supports are extended perpendicular to said left side.

12. The cargo container of claim 11 wherein said bed is constructed by joining a plurality of metal tubes together to form a flat bed.
